(19) United States
(12) Patent Application Publication
(10) Pub. No.: US 2025/0156759 A1
(43) Pub. Date: May 15, 2025

(54) LOW COMPLEXITY ML MODEL TRAINING OVER MULTIPLE GNBS

(71) Applicant: NOKIA SOLUTIONS AND NETWORKS OY, Espoo (FI)

(72) Inventors: Srilatha RAMACHANDRAN, Bengaluru (IN); Muhammad Majid BUTT, Naperville, IL (US); Shivanand KADADI, Bengaluru (IN); Afef FEKI, Sceaux (FR)

(21) Appl. No.: 18/941,936

(22) Filed: Nov. 8, 2024

(30) Foreign Application Priority Data
Nov. 10, 2023 (IN) 202341076915

(51) Int. Cl. G06N 20/00

(52) U.S. Cl. CPC G06N 20/00

(57) ABSTRACT

An apparatus including: at least one processor; and at least one memory storing instructions that, when executed by the at least one processor, cause the apparatus at least to: receive, from a plurality of network nodes, information related to at least one parameter of models of the plurality of network nodes; determine at least one cluster of the plurality of network nodes based on at least one similarity criterion and the information related to the least one parameter of models of the plurality of network nodes; and determine at least one global model for the at least one cluster using local models of network nodes that belong to the at least one cluster.

### CROSS REFERENCE TO RELATED APPLICATIONS

This application claims priority to Indian Application No. 202341076915, filed Nov. 10, 2023, the entirety of which is hereby incorporated by reference.

### TECHNICAL FIELD

The examples and non-limiting example embodiments relate generally to communications and, more particularly, to low complexity ML model training over multiple gNBs.

### BACKGROUND

It is known for a communication device to gain access to a network via a cell covered with a transmission reception point in a communication network.

### SUMMARY

In accordance with an aspect, an apparatus includes at least one processor; and at least one memory storing instructions that, when executed by the at least one processor, cause the apparatus at least to: receive, from a plurality of network nodes, information related to at least one parameter of models of the plurality of network nodes; determine at least one cluster of the plurality of network nodes based on at least one similarity criterion and the information related to the least one parameter of models of the plurality of network nodes; and determine at least one global model for the at least one cluster using local models of network nodes that belong to the at least one cluster.

In accordance with an aspect, an apparatus includes at least one processor; and at least one memory storing instructions that, when executed by the at least one processor, cause the apparatus at least to: transmit, to a network entity, information related to at least one parameter of a model of the apparatus; receive, from the network entity, an indication to perform federated learning with the network entity, in response to the apparatus being within a cluster of network nodes similar to the apparatus based on at least one similarity criterion and the information related to the at least one parameter of the model of the apparatus; and perform federated learning with the network entity, in response to receiving from the network entity the indication to perform federated learning with the network entity.

In accordance with an aspect, an apparatus includes at least one processor; and at least one memory storing instructions that, when executed by the at least one processor, cause the apparatus at least to: receive or access a global model, wherein the global model is based on federated learning with a cluster of similar network nodes; receive or access a local model of a network node; and perform inference using at least one of: the global model based on federated learning or the local model of the network node.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 is an example block diagram of a federated learning model in a wireless network.

FIG. 3 is a flowchart of the herein described method.

FIG. 4 shows cell grouping embeddings (reduced to 2d) and grouping using T-SNE and PCA algorithms.

FIG. 5 shows a CA Scell selection NN model.

FIG. 6 shows a signaling diagram with an example gNB for an FL process and a gNB for transfer learning.

FIG. 7 is an example apparatus configured to implement the examples described herein.

FIG. 8 shows a representation of an example of non-volatile memory media used to store instructions that implement the examples described herein.

FIG. 9 is an example method, based on the examples described herein.

FIG. 10 is an example method, based on the examples described herein.

FIG. 11 is an example method, based on the examples described herein.

### DETAILED DESCRIPTION OF EXAMPLE EMBODIMENTS

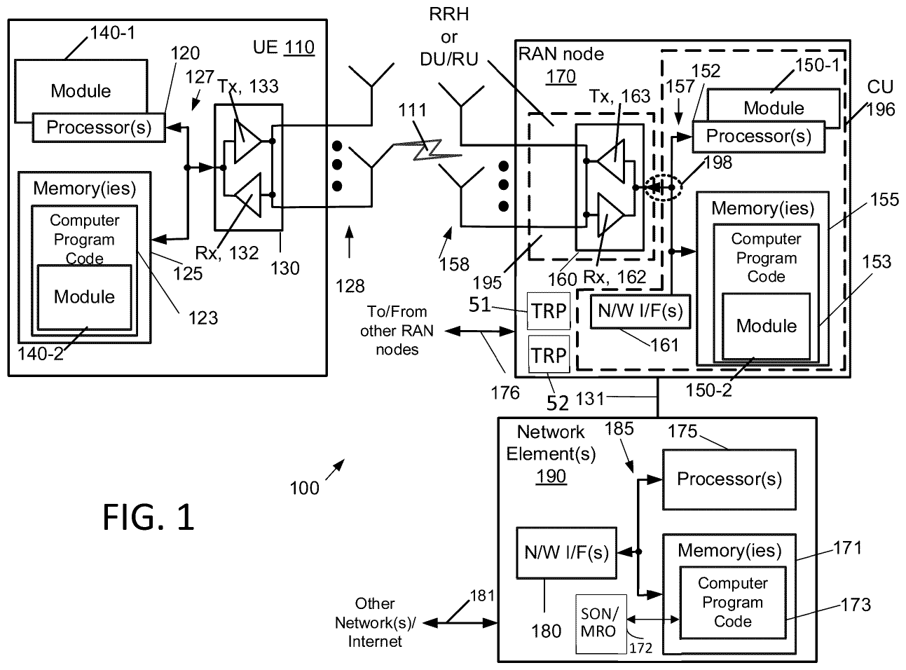

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Many applications in mobile networks require a large amount of data from multiple distributed sources like UEs or distributed gNBs to be used to train a single common model. To minimize the data exchange between the distributed units from where the data is generated and the centralized units where the common model needs to be created, the concept of federated learning (FL) may be applied. FL is a form of machine learning where instead of model training at a single node, different versions of the model are trained locally at the different distributed hosts and then aggregated at a central entity. This is different from distributed machine learning, where a single ML model is trained at distributed nodes to use computation power of different nodes. In other words, FL is different from distributed learning in the sense that for FL: 1) each distributed node in a FL scenario has its own local training data which may not come from the same distribution as the data at other nodes; 2) each node computes parameters for its local ML model and 3) the central host does not compute a version or part of the model but combines parameters of all the distributed models to generate a global model. The global model is thereafter shared with the distributed nodes. The objective of this approach is to keep the training dataset where it is generated and perform the model training locally at each individual learner in the federation.

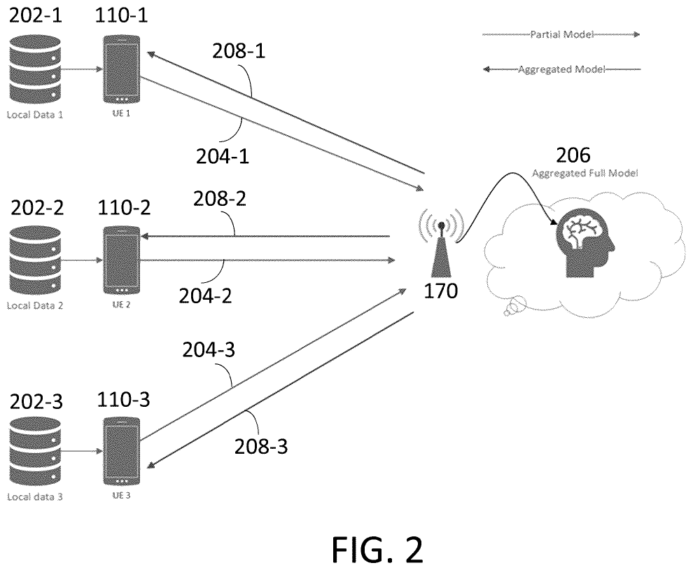

FIG. 2 is an example block diagram for a federated learning model in a wireless network. Note that the partial models (transmitted at 204-1, 204-2, 204-3) and the aggregated model (transmitted at 208-1, 208-2, 208-3) both are transmitted on regular communication links. FIG. 2 shows UEs (110-1, 110-2, 110-3) serving as local learners and a gNB 170 functioning as an aggregator node. After training a local model, each individual learner (110-1, 110-2, 110-3) transfers (at 204-1, 204-2, 204-3) its local model parameters (202-1, 202-2, 203-3), instead of a raw training dataset, to an aggregating unit 170. The aggregating unit 170 utilizes the local model parameters (202-1, 202-2, 203-3) to update a global model 206 which may eventually be fed back (at 208-1, 208-2, 208-3) to the local learners (110-1, 110-2, 110-3) for further iterations until global model 206 converges. As a result, each local learner (110-1, 110-2, 110-3) benefits from the datasets of the other local learners (110-1, 110-2, 110-3) only through the global model 206, shared by the aggregator 170, without explicitly accessing high volume of privacy-sensitive data available at each of the other local learners. This is illustrated in FIG. 2.

Summarizing, the FL training process includes the following main steps (1-4):
1. Initialization: a machine learning model (e.g., linear regression, neural network) is chosen to be trained on local nodes and initialized.
2. Client selection: a fraction of local nodes is selected to start training on local data. The selected nodes acquire the current statistical model while the others wait for the next federated round.
3. Reporting and Aggregation: each selected node sends its local model to the server for aggregation. The central server aggregates the received models and sends back the model updates to the nodes.
4. Termination: once a pre-defined termination criterion is met (e.g., a maximum number of iterations is reached) the central server aggregates the updates and finalizes the global model.

Described herein is use of the FL concept to train a single model for a group of gNBs with similar training data.

An approach is to use an iterative method for the initialization of a Q-learning model applied over training data of multiple gNBs. However, this approach does not differentiate gNBs based on their data and data from all gNBs is treated to train one ML model. The method described herein addresses the problem when training data from different gNBs is sufficiently different and various groups of gNBs having similar data can be identified.

Training a supervised learning model with targeted accuracy and generalization capabilities can be costly and time consuming, especially when made in each gNB individually. In many cases, the ML functionality is run on several cells.

Federated learning can be employed to ensure generalization of the model over several cells with a trade-off with regards to the model accuracy. However, the training in federated learning can be very time consuming and resource hungry if data from various nodes belongs to entirely different distributions.

Thus, the problem solved with the examples described herein is the following: How to improve the training process for an ML model that requires training using data from multiple cells with sufficiently different data distributions, by jointly employing federated learning and transfer learning?

The herein described solution comprises a procedure and related signaling enhancements which allow optimizing the learning strategy over a group of cells through joint employment of a combination of federated and transfer learning.

The concept of embeddings is used with the herein described examples. The concept of embeddings is defined as: embeddings are multiple vectors/location co-ordinates on a real value line (continuous line). As part of the model training embeddings are learned. If you consider embeddings are location coordinates, then similar models will be nearer to each other. The Euclidian distance between the vectors may be used to find the most similar models. Embeddings are vectors or arrays of numbers that represent the meaning and the context of the tokens that the model processes and generates. Embeddings are derived from the parameters or the weights of the model and are used to encode and decode the input and output texts. An embedding of the parameters of a model may result in the embedding having less dimensions than the parameters of the model or the model, thus the embedding process may be a data dimensionality reduction process. A decoding or reconstruction of the embedding may also be used by the examples described herein.

### Main Features:

Consider a set of N cells with each cell having a unique training data set. Instead of training an individual ML model for each cell (which may not be feasible for fast moving UEs with frequent handovers between different cells), described herein is the following ML model training scheme that combines FL and TL methods:
Step 1: A grouping is performed first on the cells using a similarity criterion. Embodiment #1: The similarity criteria here is specifically decided based on the embeddings sent out by each local node together with the local model. Embodiment #2: The similarity criteria test can also be based on the local training data samples. Note that only similar cells are grouped together. Thus, it is possible to obtain a set of n1 groups of cells and the rest of the individual cells do not belong to any group.
Step 2: Federated learning is then applied on each group of cells, which allows to obtain n1 global FL models.
Step 3: Step 3 involves a process for each individual cell. Embodiment #1: Search the closest group of cells with similar training data and do model training via transfer learning on it to obtain a new model. Embodiment #2: Perform local ML training for the cells with data not similar to data of any cell.

The herein described solution is further described in detail next assuming that the same ML framework or functionality is running at several cells or nodes, which was used to previously train an ML model in each cell individually.

Find Nodes which have similar local models. As a part of NN training in local node, embeddings (large vector) can be learned for the local model. Embeddings can be treated as a local model signature; similar models are near in the embedding vector space. Each node sends embeddings along with a trained local model to the OAM. The OAM determines the groups based on the embeddings and creates a global FL model per group using a local model of the cell belonging to that group, or using respective local models of the respective cells belonging to that group (e.g. a respective subset of the local models of a respective subset of the cells belonging to that group). Transfer learning can be used for the nodes which do not belong to any group (non-similar nodes).

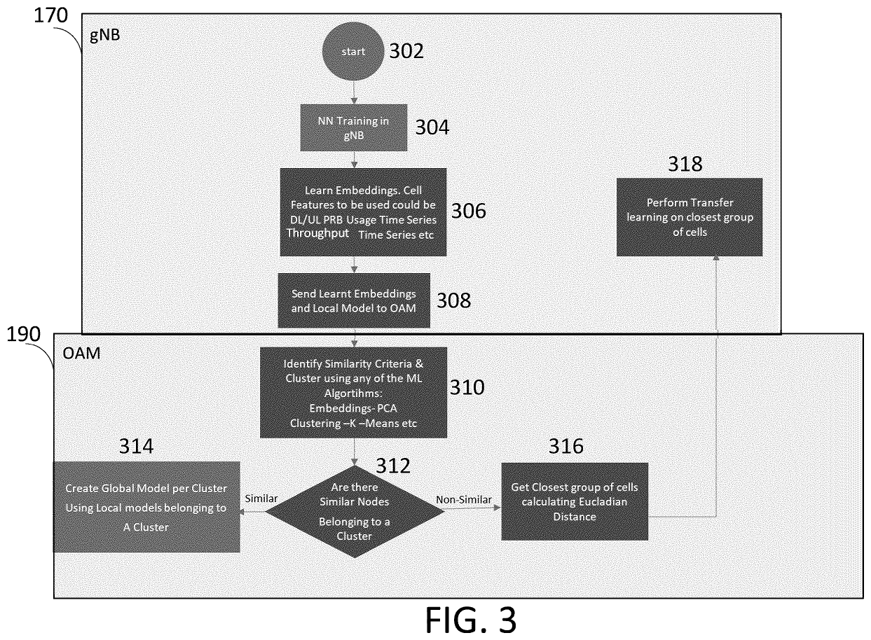

The detailed steps of the proposed solution are summarized in the flow chart shown in FIG. 3. In FIG. 3, the gNB 170 performs operations 302, 304, 306, 308, and 318, and OAM 190 performs operations 310, 312, 314, and 316. At 302, the process starts. At 304, the gNB 170 performs NN training. At 306, embeddings are learned. At 306, the cell features to be used to learn the embeddings could be a DL or UL PRB usage time series, a throughput time series, etc. At 308, the gNB 170 sends the learned embeddings and a local model to OAM 190.

At 310, the OAM 190 identifies similarity criteria and a cluster using an ML algorithm such as embeddings—with PCA and/or a clustering K-means method. At 312, the OAM 190 determines whether there are similar nodes belonging to a cluster. If at 312 the OAM 190 determines that there are similar nodes belonging to a cluster, the method transitions to 314. If at 312 the OAM 190 determines a node that does not belong to a cluster, or that there are no similar nodes belonging to a cluster, the method transitions to 316. At 314, the OAM 190 creates a global model per cluster using local models belonging to a cluster. At 316, the OAM 190 gets a closest group of cells by calculating a Euclidean distance.

At 318, the gNB 170 performs transfer learning on a closest group of cells. In particular, the gNB 170 performs transfer learning using a trained model of the cluster whose embeddings seem to be closest to embeddings of gNB 170. In other words, the gNB 170 is similar to a particular cluster but not enough to be part of the cluster. Then, the trained model of the cluster is used as a starting point to train a local model of the gNB, and this is called transfer learning. Transfer learning is used to train a local model fast. Once the local model of the gNB 170 is trained, the gNB 170 can use the trained model locally.

Embeddings (306). Some of the cell features to be used for grouping the cells include but are not limited to a DL or UL PRB usage time series, a throughput time series, and a number of RRC connected users or active users.

Identifying Similarity Criteria, Reducing Dimensions and Grouping (310). Using unsupervised machine learning, various ML algorithms can be used to first come up with embeddings for each cell (say dimensions up to 10) and based on the embedding groups of cells can be obtained keeping in mind the number of groups and size of these groups. ML algorithms or tools to be used may include (these are examples, and other methods could be used) 1) for Embedding, PCA or t-SNE, 2) for clustering, —K-means, GMM, or DBSCAN, and 3) for Anomaly detection, density estimation or thresholding.

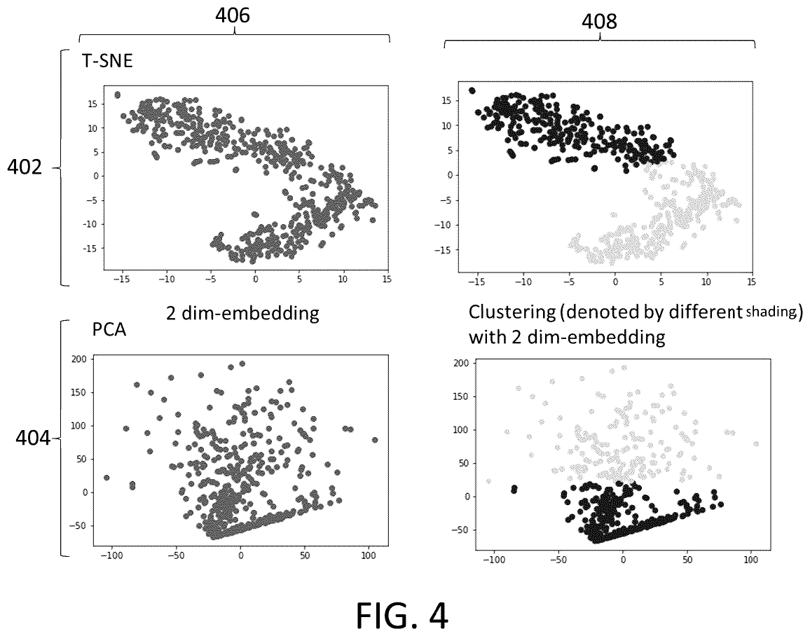

FIG. 4 shows field data results for cell grouping embeddings 406 (reduced to 2d) and grouping 408 using T-SNE (402) and PCA (404) algorithms. Data used to generate the results included 500 cells and reported data worth 1 week for each cell. Cell features that were used for arriving at the embeddings included a DL and UL PRB usage time series, a throughout time series, and a number of RRC connected users and active users. Using ML algorithms the dimension of the data was reduced from 10 d to 2 d for each cell, and further grouping the cells was performed using ML algorithms.

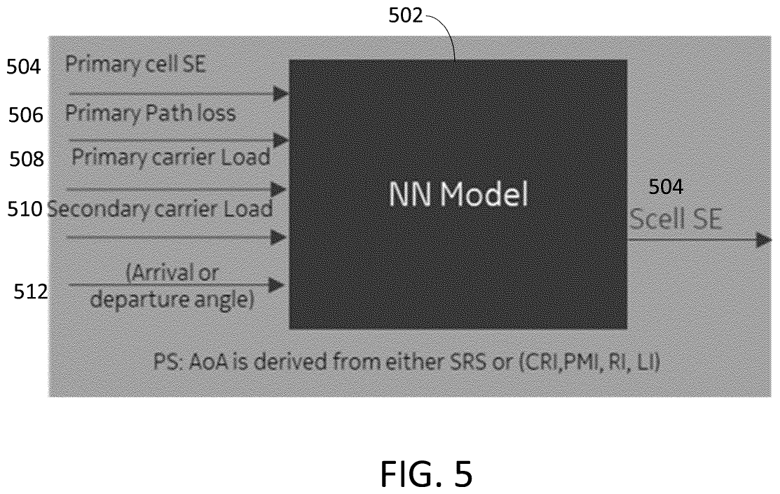

FIG. 5 shows the problem with respect to the CA secondary cell selection feature and how the herein described solution enables secondary cell selection optimization.

In the case of CA Scell selection, the local model which predicts Scell spectral efficiency (SE) for one cell may not work well for another cell although the inputs for predicting the SE remain the same. The reason being the environment has an impact on the prediction. The model learns the cell surrounding environment so the model becomes very cell specific. And with federated learning, the global model tends to lose this cell specific information when averaging and/or aggregating, which causes a performance dip. Hence finding similar cells and forming a group becomes imperative.

In particular, FIG. 5 shows a NN model 502 learned based on the examples described herein. The NN model 502 takes as input a primary cell spectral efficiency (SE) 504, a primary pathloss 506, a primary carrier load 508, a secondary carrier load 510, and an arrival or departure angle 512. The arrival or departure angle may be derived from either SRS, CRI, PMI, RI, or LI. Based on the input, the NN model 502 generates a prediction or estimate of a secondary cell spectral efficiency.

### Main Embodiment: Signaling Enhancement

ML embedded at the gNB sends the local model information to the OAM. ML embedded at the OAM further performs the identification of groups and generation of a global model.

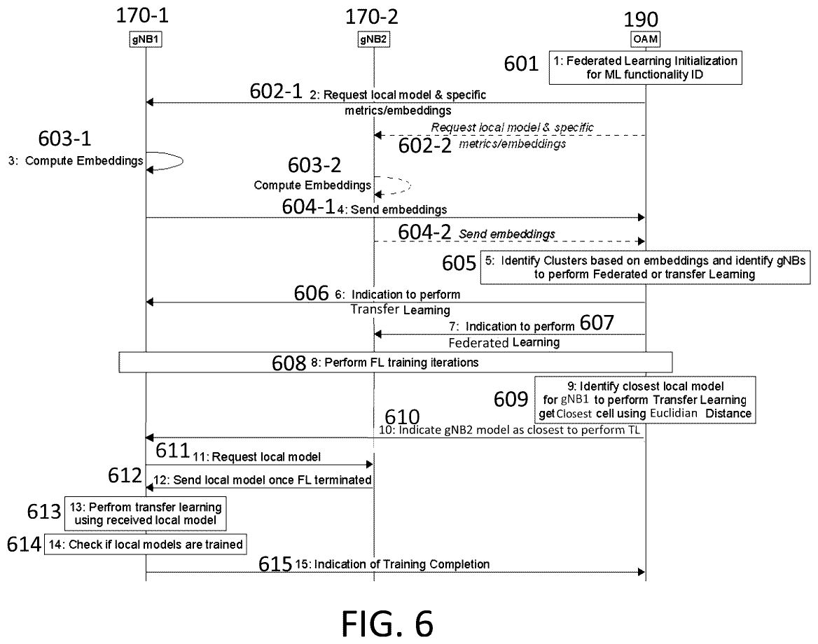

FIG. 6 highlights the signaling exchange between an NG-RAN node and OAM (but could be similar for other entities in the network handling the establishment of these rules). Thus, FIG. 6 shows signaling with an example gNB for an FL process and gNB for transfer learning.

At 601, the OAM 190 performs federated learning initialization for an ML functionality ID. At 602-1, the OAM 190 requests a local model and specific metrics or embeddings from gNB1 170-1. At 602-2, the OAM 190 requests a local model and specific metrics or embeddings from gNB2 170-2. At 603-1, gNB1 170-1 computes embeddings. At 603-2, gNB2 170-2 computes embeddings. At 604-1, gNB1 170-1 sends the computed embeddings to OAM 190. At 604-2, gNB2 170-2 sends the computed embeddings to OAM 190. At 605, the OAM 190 identifies clusters based on the embeddings received from gNB1 170-1 and gNB2 170-2, and identifies gNBs to perform federated or transfer learning.

At 606, the OAM 190 transmits to gNB1 170-1 an indication to perform transfer learning (e.g. the OAM 190 at 605 identified gNB1 170-1 to perform transfer learning). At 607, OAM 190 transmits to gNB2 170-2 an indication to perform federated learning (e.g. the OAM 190 at 605 identified gNB2 170-2 to perform federated learning). At 608, gNB1 170-1, gNB2 170-2, and OAM 190 perform FL training iterations. At 609, the OAM 190 identifies a closest local model (e.g. gNB2 170-2) for gNB1 170-1 to perform transfer learning by determining the closest cell using the Euclidean distance. At 610, OAM 190 transmits an indication to gNB1 170-1 that the model for gNB2 170-2 is the closest for performing transfer learning. At 611, gNB1 170-1 requests a local model from gNB2 170-2. At 612, gNB2 170-2 transmits to the gNB1 170-1 a local model once FL is terminated. At 613, gNB1 170-1 performs transfer learning using the local model received from gNB2 170-2. The transfer learning starts and speeds up the process of training the model of gNB1 170-1. At 614, gNB1 170-1 checks if local models are trained. At 615, gNB1 170-1 transmits to OAM 190 an indication of training completion.

Alternate Embodiment: in the herein described method, transfer learning has been proposed to speed up the training process for the cells which do not have training data similar to any other cell (are not part of any group). However, this is an optional feature, and these cells that do not have training data similar to any other cell (are not part of any group) can just perform local model learning without this using TL. In this case, no communication is required between gNBs to receive data for starting transfer learning and gNBs can just perform learning based on their local data.

Applicability: the herein described solution may be implemented within an AI/ML based 5G CA Scell selection machine, function, or feature, where ML training is done at the base station (using an embedded ML framework).

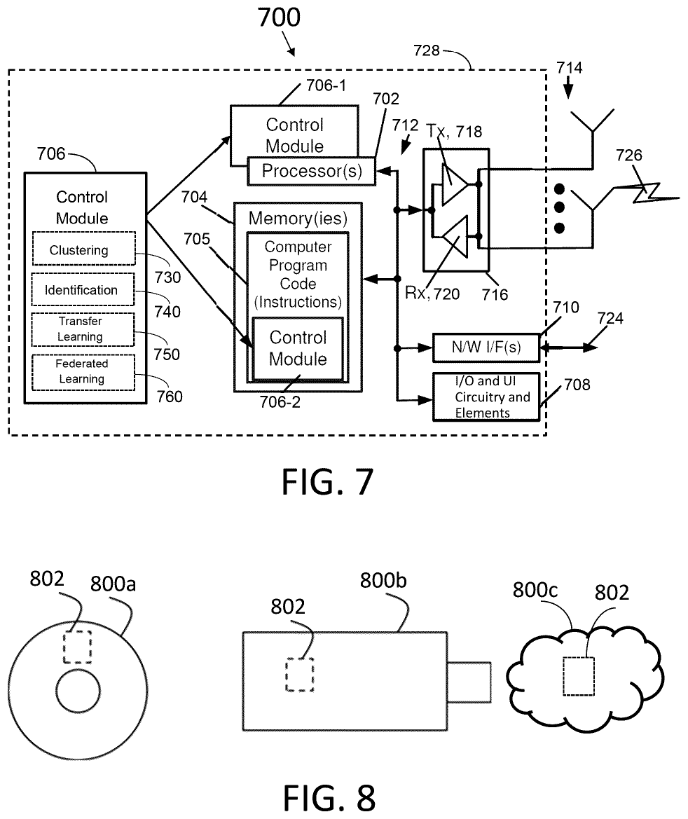

FIG. 7 is an example apparatus 700, which may be implemented in hardware, configured to implement the examples described herein. The apparatus 700 comprises at least one processor 702 (e.g. an FPGA and/or CPU), one or more memories 704 including computer program code 705, the computer program code 705 having instructions to carry out the methods described herein, wherein the at least one memory 704 and the computer program code 705 are configured to, with the at least one processor 702, cause the apparatus 700 to implement circuitry, a process, component, module, or function (implemented with control module 706) to implement the examples described herein. The memory 704 may be a non-transitory memory, a transitory memory, a volatile memory (e.g. RAM), or a non-volatile memory (e.g. ROM).

Optionally included clustering 730 may implement identification of clusters based on embeddings, such as that performed with OAM 190 at item 605 of FIG. 6. Optionally included identification 740 may implement identification of gNBs to perform federated or transfer learning, such as that performed with OAM 190 at item 605 of FIG. 6. Identification 740 may implement identification of a closest local model for a gNB to perform transfer learning, such as that performed with OAM 190 at item 609 of FIG. 6. Optionally included transfer learning 750 may implement transfer learning as described herein, such as that performed with gNB1 170-1 at item 613 of FIG. 6. Optionally included federated learning 760 may implement federated learning as described herein, such as that performed with gNB1 170-1, gNB2 170-2, and OAM 190 at item 608 of FIG. 6.

The apparatus 700 includes a display and/or I/O interface 708, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 700 includes one or more communication e.g. network (N/W) interfaces (I/F(s)) 710. The communication I/F(s) 710 may be wired and/or wireless and communicate over the Internet/other network(s) via any communication technique including via one or more links 724. The link(s) 724 may be the link(s) 131 and/or 176 from FIG. 1. The link(s) 131 and/or 176 from FIG. 1 may also be implemented using transceiver(s) 716 and corresponding wireless link(s) 726. The communication I/F(s) 710 may comprise one or more transmitters or one or more receivers.

The transceiver 716 comprises one or more transmitters 718 and one or more receivers 720. The transceiver 716 and/or communication I/F(s) 710 may comprise standard well-known components such as an amplifier, filter, frequency-converter, (de) modulator, and encoder/decoder circuitries and one or more antennas, such as antennas 714 used for communication over wireless link 726.

The control module 706 of the apparatus 700 comprises one of or both parts 706-1 and/or 706-2, which may be implemented in a number of ways. The control module 706 may be implemented in hardware as control module 706-1, such as being implemented as part of the one or more processors 702. The control module 706-1 may be implemented also as an integrated circuit or through other hardware such as a programmable gate array. In another example, the control module 706 may be implemented as control module 706-2, which is implemented as computer program code (having corresponding instructions) 705 and is executed by the one or more processors 702. For instance, the one or more memories 704 store instructions that, when executed by the one or more processors 702, cause the apparatus 700 to perform one or more of the operations as described herein. Furthermore, the one or more processors 702, the one or more memories 704, and example algorithms (e.g., as flowcharts and/or signaling diagrams), encoded as instructions, programs, or code, are means for causing performance of the operations described herein.

The apparatus 700 to implement the functionality of control 706 may be UE 110, RAN node 170 (e.g. gNB), or network element(s) 190 (e.g. LMF 190). Thus, processor 702 may correspond to processor(s) 120, processor(s) 152 and/or processor(s) 175, memory 704 may correspond to one or more memories 125, one or more memories 155 and/or one or more memories 171, computer program code 705 may correspond to computer program code 123, computer program code 153, and/or computer program code 173, control module 706 may correspond to module 140-1, module 140-2, module 150-1, and/or module 150-2, and communication I/F(s) 710 and/or transceiver 716 may correspond to transceiver 130, antenna(s) 128, transceiver 160, antenna(s) 158, N/W I/F(s) 161, and/or N/W I/F(s) 180. Alternatively, apparatus 700 and its elements may not correspond to either of UE 110, RAN node 170, or network element(s) 190 and their respective elements, as apparatus 700 may be part of a self-organizing/optimizing network (SON) node or other node, such as a node in a cloud.

Apparatus 700 may also correspond to UE1 110-1, UE2 110-2, UE3 110-3 (where UE1 110-1, UE2 110-2, UE3 110-3 are configured similarly to UE 110), gNB1 170-1, gNB2 170-2 (where gNB1 170-1 and gNB2 170-2 are configured similarly to RAN node 170), or OAM 190 (e.g. when OAM 190 is configured similarly to one or more network elements 190).

The apparatus 700 may also be distributed throughout the network (e.g. 100) including within and between apparatus 700 and any network element (such as a network control element (NCE) 190 and/or the RAN node 170 and/or UE 110).

Interface 712 enables data communication and signaling between the various items of apparatus 700, as shown in FIG. 7. For example, the interface 712 may be one or more buses such as address, data, or control buses, and may include any interconnection mechanism, such as a series of lines on a motherboard or integrated circuit, fiber optics or other optical communication equipment, and the like. Computer program code (e.g. instructions) 705, including control 706 may comprise object-oriented software configured to pass data or messages between objects within computer program code 705. The apparatus 700 need not comprise each of the features mentioned, or may comprise other features as well. The various components of apparatus 700 may at least partially reside in a common housing 728, or a subset of the various components of apparatus 700 may at least partially be located in different housings, which different housings may include housing 728.

FIG. 8 shows a schematic representation of non-volatile memory media 800a (e.g. computer/compact disc (CD) or digital versatile disc (DVD)) and 800b (e.g. universal serial bus (USB) memory stick) and 800c (e.g. cloud storage for downloading instructions and/or parameters 802 or receiving emailed instructions and/or parameters 802) storing instructions and/or parameters 802 which when executed by a processor allows the processor to perform one or more of the steps of the methods described herein. Instructions and/or parameters 802 may represent a non-transitory computer readable medium.

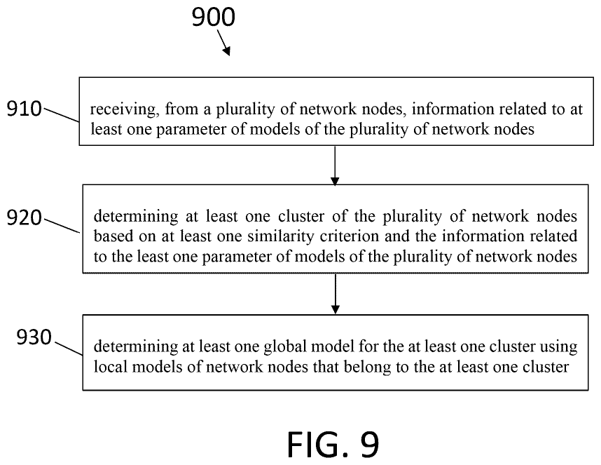

FIG. 9 is an example method 900, based on the example embodiments described herein. At 910, the method includes receiving, from a plurality of network nodes, information related to at least one parameter of models of the plurality of network nodes. At 920, the method includes determining at least one cluster of the plurality of network nodes based on at least one similarity criterion and the information related to the least one parameter of models of the plurality of network nodes. At 930, the method includes determining at least one global model for the at least one cluster using local models of network nodes that belong to the at least one cluster. Method 900 may be performed with one or more network elements 190 (e.g. OAM 190) or apparatus 700.

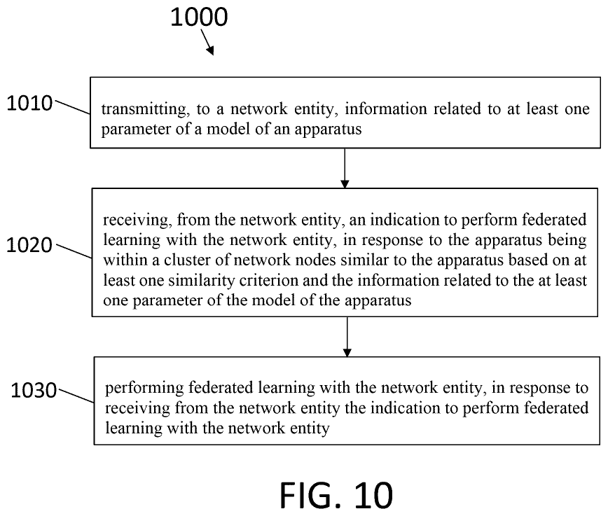

FIG. 10 is an example method 1000, based on the example embodiments described herein. At 1010, the method includes transmitting, to a network entity, information related to at least one parameter of a model of an apparatus. At 1020, the method includes receiving, from the network entity, an indication to perform federated learning with the network entity, in response to the apparatus being within a cluster of network nodes similar to the apparatus based on at least one similarity criterion and the information related to the at least one parameter of the model of the apparatus. At 1030, the method includes performing federated learning with the network entity, in response to receiving from the network entity the indication to perform federated learning with the network entity. Method 1000 may be performed with RAN node 170 (e.g. gNB 170) or apparatus 700.

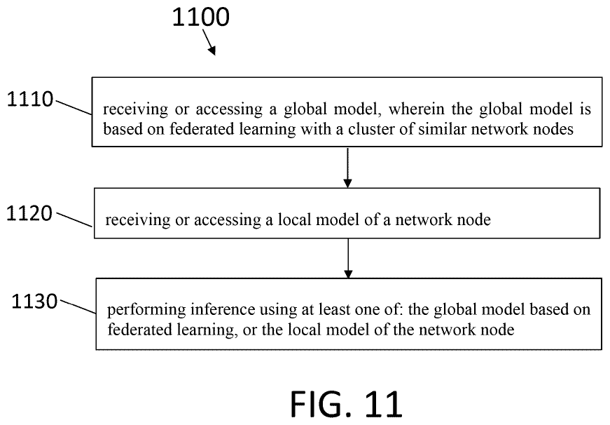

FIG. 11 is an example method 1100, based on the example embodiments described herein. At 1110, the method includes receiving or accessing a global model, wherein the global model is based on federated learning with a cluster of similar network nodes. At 1120, the method includes receiving or accessing a local model of a network node. At 1130, the method includes performing inference using at least one of: the global model based on federated learning, or the local model of the network node. Method 1100 may be performed with UE 110 or apparatus 700.

The following examples are provided and described herein.
Example 1. An apparatus including: at least one processor; and at least one memory storing instructions that, when executed by the at least one processor, cause the apparatus at least to: receive, from a plurality of network nodes, information related to at least one parameter of models of the plurality of network nodes; determine at least one cluster of the plurality of network nodes based on at least one similarity criterion and the information related to the least one parameter of models of the plurality of network nodes; and determine at least one global model for the at least one cluster using local models of network nodes that belong to the at least one cluster.
Example 2. The apparatus of example 1, wherein determining the at least one global model for the at least one cluster is performed using federated learning with the network nodes that belong to the at least one cluster.
Example 3. The apparatus of any of examples 1 to 2, wherein the instructions, when executed by the at least one processor, cause the apparatus at least to: transmit, to the network nodes within the at least one cluster, an indication to perform local model training for federated learning; wherein the indication to perform federated learning is transmitted to the network nodes within the at least one cluster, in response to the network nodes belonging to the at least one cluster.
Example 4. The apparatus of any of examples 1 to 3, wherein the instructions, when executed by the at least one processor, cause the apparatus at least to: determine that a network node does not belong to any of the at least one cluster; and transmit, to the network node that does not belong to any of the at least one cluster, an indication to perform local model training, in response to determining that the network node does not belong to any of the at least one cluster.
Example 5. The apparatus of example 4, wherein the local model training is performed using transfer learning.
Example 6. The apparatus of any of examples 4 to 5, wherein the determine a model of a second network node configured to be used with a first network node to perform transfer learning; wherein the first network node comprises the network node that does not belong to any of the at least one cluster; and transmit, to the first network node, an indication to perform transfer learning using the determined model of the second network node.
Example 7. The apparatus of example 6, wherein the instructions, when executed by the at least one processor, cause the apparatus at least to: determine the model of the second network node configured to be used with the first network node to perform transfer learning based on a Euclidean distance between a model of the first network node and the model of the second network node; wherein the Euclidean distance between the model of the first network node and the model of the second network node is smaller than Euclidean distances between the model of the first network node and models of other network nodes of the plurality of network nodes.
Example 8. The apparatus of any of examples 4 to 7, wherein determining that the network node does not belong to any of the at least one cluster is based on at least one or more of density estimation, or thresholding.
Example 9. The apparatus of any of examples 4 to 8, wherein the instructions, when executed by the at least one processor, cause the apparatus at least to: determine a trained global model of a cluster, the trained global model configured to be used with the network node that does not belong to any of the at least one cluster; determine, based on a similarity criterion, a similarity metric of the network node that does not belong to any of the at least one cluster to be more similar to a similarity metric of networks nodes that belong to the cluster than a similarity metric of network nodes that do not belong to the cluster; transmit, to the network node that does not belong to any of the at least one cluster, an indication to perform transfer learning using the trained global model of the cluster.
Example 10. The apparatus of any of examples 1 to 9, wherein the information related to the at least one parameter of models of the plurality of network nodes used to determine the at least one cluster of the plurality of network nodes comprises at least one of: embeddings of the at least one parameter of models of the plurality of network nodes, or local training data samples used to generate the models of the plurality of network nodes.
Example 11. The apparatus of example 10, wherein the embeddings are based on at least one of: a downlink physical resource block usage time series, or an uplink physical resource block usage time series, or a throughput time series, or a number of radio resource control connected users, or a number of radio resource control active users, or principal component analysis, or t-distributed stochastic neighbor embedding.
Example 12. The apparatus of any of examples 1 to 11, wherein the instructions, when executed by the at least one processor, cause the apparatus at least to: transmit, to the plurality of network nodes, a request for the information related to at least one parameter of models of the plurality of network nodes; wherein the information related to the at least one parameter of models of the plurality of network nodes is received in response to the transmitting the request for the information.
Example 13. The apparatus of any of examples 1 to 12, wherein the instructions, when executed by the at least one processor, cause the apparatus at least to: receive, from the plurality of network nodes, trained local models of the plurality of network nodes; and determine the at least one global model using at least some of the trained local models received from the plurality of network nodes; wherein the information related to at least one parameter of models of the plurality of network nodes received from the plurality of network nodes comprises the trained local models.
Example 14. The apparatus of any of examples 1 to 13, wherein the instructions, when executed by the at least one processor, cause the apparatus at least to: transmit, to the network nodes within the at least one cluster, the at least one global model.
Example 15. The apparatus of any of examples 1 to 14, wherein the instructions, when executed by the at least one processor, cause the apparatus at least to: provide access to the at least one global model to the network nodes within the at least one cluster.
Example 16. The apparatus of any of examples 1 to 15, wherein the instructions, when executed by the at least one processor, cause the apparatus at least to: determine a global model per the at least one cluster using the information related to the at least one parameter of models of the plurality of network nodes.
Example 17. The apparatus of any of examples 1 to 16, wherein the plurality of network nodes comprise radio access network nodes.
Example 18. The apparatus of any of examples 1 to 17, wherein the at least one global model is a trained global model for the respective at least one cluster.
Example 19. An apparatus including: at least one processor; and at least one memory storing instructions that, when executed by the at least one processor, cause the apparatus at least to: transmit, to a network entity, information related to at least one parameter of a model of the apparatus; receive, from the network entity, an indication to perform federated learning with the network entity, in response to the apparatus being within a cluster of network nodes similar to the apparatus based on at least one similarity criterion and the information related to the at least one parameter of the model of the apparatus; and perform federated learning with the network entity, in response to receiving from the network entity the indication to perform federated learning with the network entity.
Example 20. The apparatus of example 19, wherein the instructions, when executed by the at least one processor, cause the apparatus at least to: receive, from the network entity, an indication to perform local model training for the federated learning.
Example 21. The apparatus of any of examples 19 to 20, wherein the instructions, when executed by the at least one processor, cause the apparatus at least to: receive, from the network entity, an indication to perform local model training, in response to the apparatus not belonging to any cluster of network nodes.
Example 22. The apparatus of example 21, wherein the local model training is performed using transfer learning.
Example 23. The apparatus of any of examples 21 to 22, wherein the apparatus not belonging to any cluster is based on at least one or more of density estimation, or thresholding.
Example 24. The apparatus of any of examples 19 to 23, wherein the instructions, when executed by the at least one processor, cause the apparatus at least to: receive, from the network entity, an indication to perform transfer learning with a network node, in response to the apparatus not belonging to any cluster of network nodes; and perform transfer learning using the network node received with the indication to perform transfer learning received from the network entity.
Example 25. The apparatus of example 24, wherein the network node belongs to a cluster of network nodes having similar local models.
Example 26. The apparatus of any of examples 24 to 25, wherein the receive, from the network entity, an indication of a model of the network node with which to perform the transfer learning.
Example 27. The apparatus of example 26, wherein a Euclidean distance between a model of the apparatus and the model of the network node with which to perform transfer learning is smaller than Euclidean distances between the model of the apparatus and models of other network nodes.
Example 28. The apparatus of any of examples 19 to 27, wherein the instructions, when executed by the at least one processor, cause the apparatus at least to: receive, from the network entity, an indication to perform transfer learning with a trained global model of a cluster, in response to the apparatus not belonging to any cluster of network nodes; wherein, based on a similarity criterion, a similarity metric of the apparatus that does not belong to any cluster of network nodes is more similar to a similarity metric of network nodes that belong to the cluster having the trained global model than to a similarity metric of networks nodes that do not belong to the cluster having the trained global model.
Example 29. The apparatus of any of examples 19 to 28, wherein the information related to the at least one parameter of a model of the apparatus comprises at least one of: embeddings of the at least one parameter of the model of the apparatus, or local training data samples used to generate the model of the apparatus.
Example 30. The apparatus of example 29, wherein the embeddings are based on at least one of: a downlink physical resource block usage time series, or an uplink physical resource block usage time series, or a throughput time series, or a number of radio resource control connected users, or a number of radio resource control active users, or principal component analysis, or t-distributed stochastic neighbor embedding.
Example 31. The apparatus of any of examples 19 to 30, wherein the instructions, when executed by the at least one processor, cause the apparatus at least to: receive, from the network entity, a request for the information related to the at least one parameter of the model of the apparatus; wherein the information related to the at least one parameter of the model of the apparatus is transmitted in response to receiving the request for the information.
Example 32. The apparatus of any of examples 19 to 31, wherein the transmit, to the network entity, a trained local model of the apparatus, the trained local model configured to be used to learn a global model for the cluster of the network nodes; wherein the information related to the at least one parameter of a model of the apparatus transmitted to the network entity comprises the trained local model of the apparatus.
Example 33. The apparatus of any of examples 19 to 32, wherein the instructions, when executed by the at least one processor, cause the apparatus at least to: receive, from the network entity, the global model; and perform inference using the global model.
Example 34. The apparatus of any of examples 19 to 33, wherein the instructions, when executed by the at least one processor, cause the apparatus at least to: obtain access to the global model; and perform inference using the global model.
Example 35. The apparatus of any of examples 19 to 34, wherein the apparatus comprises a radio access network node.
Example 36. An apparatus including: at least one processor; and at least one memory storing instructions that, when executed by the at least one processor, cause the apparatus at least to: receive or access a global model, wherein the global model is based on federated learning with a cluster of similar network nodes; receive or access a local model of a network node; and perform inference using at least one of: the global model based on federated learning or the local model of the network node.
Example 37. The apparatus of example 36, wherein the local model is based on transfer learning with a network node that is not part of the cluster.
Example 38. The apparatus of any of examples 36 to 37, wherein the apparatus comprises a user equipment.
Example 39. A method including: receiving, from a plurality of network nodes, information related to at least one parameter of models of the plurality of network nodes; determining at least one cluster of the plurality of network nodes based on at least one similarity criterion and the information related to the least one parameter of models of the plurality of network nodes; and determining at least one global model for the at least one cluster using local models of network nodes that belong to the at least one cluster.
Example 40. A method including: transmitting, to a network entity, information related to at least one parameter of a model of an apparatus; receiving, from the network entity, an indication to perform federated learning with the network entity, in response to the apparatus being within a cluster of network nodes similar to the apparatus based on at least one similarity criterion and the information related to the at least one parameter of the model of the apparatus; and performing federated learning with the network entity, in response to receiving from the network entity the indication to perform federated learning with the network entity.
Example 41. A method including: receiving or accessing a global model, wherein the global model is based on federated learning with a cluster of similar network nodes; receiving or accessing a local model of a network node; and performing inference using at least one of: the global model based on federated learning, or the local model of the network node.
Example 42. An apparatus including: means for receiving, from a plurality of network nodes, information related to at least one parameter of models of the plurality of network nodes; means for determining at least one cluster of the plurality of network nodes based on at least one similarity criterion and the information related to the least one parameter of models of the plurality of network nodes; and means for determining at least one global model for the at least one cluster using local models of network nodes that belong to the at least one cluster.
Example 43. An apparatus including: means for transmitting, to a network entity, information related to at least one parameter of a model of an apparatus; means for receiving, from the network entity, an indication to perform federated learning with the network entity, in response to the apparatus being within a cluster of network nodes similar to the apparatus based on at least one similarity criterion and the information related to the at least one parameter of the model of the apparatus; and means for performing federated learning with the network entity, in response to receiving from the network entity the indication to perform federated learning with the network entity.
Example 44. An apparatus including: means for receiving or accessing a global model, wherein the global model is based on federated learning with a cluster of similar network nodes; means for receiving or accessing a local model of a network node; and means for performing inference using at least one of: the global model based on federated learning, or the local model of the network node.
Example 45. A computer readable medium including instructions stored thereon for performing at least the following: receiving, from a plurality of network nodes, information related to at least one parameter of models of the plurality of network nodes; determining at least one cluster of the plurality of network nodes based on at least one similarity criterion and the information related to the least one parameter of models of the plurality of network nodes; and determining at least one global model for the at least one cluster using local models of network nodes that belong to the at least one cluster.
Example 46. A computer readable medium including instructions stored thereon for performing at least the following: transmitting, to a network entity, information related to at least one parameter of a model of an apparatus; receiving, from the network entity, an indication to perform federated learning with the network entity, in response to the apparatus being within a cluster of network nodes similar to the apparatus based on at least one similarity criterion and the information related to the at least one parameter of the model of the apparatus; and performing federated learning with the network entity, in response to receiving from the network entity the indication to perform federated learning with the network entity.
Example 47. A computer readable medium including instructions stored thereon for performing at least the following: receiving or accessing a global model, wherein the global model is based on federated learning with a cluster of similar network nodes; receiving or accessing a local model of a network node; and performing inference using at least one of: the global model based on federated learning, or the local model of the network node.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended/combined with each other or with other characters using e.g. a dash, hyphen, slash, letter, or number, and may be case insensitive):
4G fourth generation
5G fifth generation
5GC 5G core network
AI artificial intelligence
AMF access and mobility management function
ASIC application-specific integrated circuit
CA carrier aggregation
CD compact/computer disc
CPU central processing unit
CRI CSI reference signal resource indicator
CSI channel state information
CU central unit or centralized unit
d dimensions, dimensional (e.g. 2d, 10d)
DBSCAN density-based spatial clustering of applications with noise
dim dimensional
DL downlink
DSP digital signal processor
DU distributed unit
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved UMTS terrestrial radio access, i.e., the LTE radio access technology
E-UTRAN E-UTRA network
F1 interface between the CU and the DU
FL federated learning
FPGA field-programmable gate array
GMM Gaussian mixture modeling
gNB base station for 5G/NR, i.e., a node providing NR user plane and control plane protocol terminations towards the UE, and connected via the NG interface to the 5GC
K number of clusters (e.g. k-means)
IAB integrated access and backhaul
ID identifier
I/F interface
I/O input/output
LI layer indicator
LMF location management function
LTE long term evolution (4G)
MAC medium access control
ML machine learning
MME mobility management entity
MN mobile networks
MRO mobility robustness optimization
NCE network control element
ng or NG new generation
ng-eNB new generation eNB
NG-RAN new generation radio access network
NN neural network
NR new radio
N/W network
OAM operations, administration and maintenance
PCA principal component analysis
PDA personal digital assistant
PDCP packet data convergence protocol
PHY physical layer
PMI precoding matrix indicator
PRB physical resource block
Q one or more expected rewards for respective one or more actions taken in a given state (e.g. Q-learning)
RAM random access memory
RAN radio access network
RI rank indicator
RLC radio link control
ROM read-only memory
RRC radio resource control
RU radio unit
Rx receive, or receiver, or reception
Scell secondary cell
SDAP service data adaptation protocol
SE spectral efficiency
SGW serving gateway
SMF session management function
SON self-organizing/optimizing network
SRS sounding reference signal
TL transfer learning
TRP transmission and reception point
t-SNE t-distributed stochastic neighbor embedding
Tx transmit, or transmitter, or transmission
UAV unmanned aerial vehicle
UE user equipment (e.g., a wireless, typically mobile device)
UI user interface
UL uplink
UMTS Universal Mobile Telecommunications System
UPF user plane function
USB universal serial bus
UTRAN UMTS terrestrial radio access network
X2 network interface between RAN nodes and between RAN and the core network
Xn network interface between NG-RAN nodes

What is claimed is:

1. An apparatus comprising:
at least one processor; and
at least one memory storing instructions that, when executed by the at least one processor, cause the apparatus at least to:
receive, from a plurality of network nodes, information related to at least one parameter of models of the plurality of network nodes;
determine at least one cluster of the plurality of network nodes based on at least one similarity criterion and the information related to the least one parameter of models of the plurality of network nodes; and
determine at least one global model for the at least one cluster using local models of network nodes that belong to the at least one cluster.

2. The apparatus of claim 1, wherein determining the at least one global model for the at least one cluster is performed using federated learning with the network nodes that belong to the at least one cluster.

3. The apparatus of claim 1, wherein the instructions, when executed by the at least one processor, cause the apparatus at least to:
transmit, to the network nodes within the at least one cluster, an indication to perform local model training for federated learning;
wherein the indication to perform federated learning is transmitted to the network nodes within the at least one cluster, in response to the network nodes belonging to the at least one cluster.

4. The apparatus of claim 1, wherein the instructions, when executed by the at least one processor, cause the apparatus at least to:
determine that a network node does not belong to any of the at least one cluster; and
transmit, to the network node that does not belong to any of the at least one cluster, an indication to perform local model training, in response to determining that the network node does not belong to any of the at least one cluster.

5. The apparatus of claim 4, wherein the local model training is performed using transfer learning.

6. The apparatus of claim 4, wherein the instructions, when executed by the at least one processor, cause the apparatus at least to:
determine a model of a second network node configured to be used with a first network node to perform transfer learning;
wherein the first network node comprises the network node that does not belong to any of the at least one cluster; and
transmit, to the first network node, an indication to perform transfer learning using the determined model of the second network node.

7. The apparatus of claim 6, wherein the instructions, when executed by the at least one processor, cause the apparatus at least to:
determine the model of the second network node configured to be used with the first network node to perform transfer learning based on a Euclidean distance between a model of the first network node and the model of the second network node;
wherein the Euclidean distance between the model of the first network node and the model of the second network node is smaller than Euclidean distances between the model of the first network node and models of other network nodes of the plurality of network nodes.

8. The apparatus of claim 4, wherein determining that the network node does not belong to any of the at least one cluster is based on at least one or more of density estimation, or thresholding.

9. The apparatus of claim 4, wherein the instructions, when executed by the at least one processor, cause the apparatus at least to:
determine a trained global model of a cluster, the trained global model configured to be used with the network node that does not belong to any of the at least one cluster;
determine, based on a similarity criterion, a similarity metric of the network node that does not belong to any of the at least one cluster to be more similar to a similarity metric of networks nodes that belong to the cluster than a similarity metric of network nodes that do not belong to the cluster; and
transmit, to the network node that does not belong to any of the at least one cluster, an indication to perform transfer learning using the trained global model of the cluster.

10. The apparatus of claim 1, wherein the information related to the at least one parameter of models of the plurality of network nodes used to determine the at least one cluster of the plurality of network nodes comprises at least one of:
embeddings of the at least one parameter of models of the plurality of network nodes, or
local training data samples used to generate the models of the plurality of network nodes.

11. The apparatus of claim 10, wherein the embeddings are based on at least one of:
a downlink physical resource block usage time series, or
an uplink physical resource block usage time series, or
a throughput time series, or
a number of radio resource control connected users, or
a number of radio resource control active users, or
principal component analysis, or
t-distributed stochastic neighbor embedding.

12. The apparatus of claim 1, wherein the instructions, when executed by the at least one processor, cause the apparatus at least to:
transmit, to the plurality of network nodes, a request for the information related to at least one parameter of models of the plurality of network nodes;
wherein the information related to the at least one parameter of models of the plurality of network nodes is received in response to the transmitting the request for the information.

13. The apparatus of claim 1, wherein the instructions, when executed by the at least one processor, cause the apparatus at least to:
receive, from the plurality of network nodes, trained local models of the plurality of network nodes; and
determine the at least one global model using at least some of the trained local models received from the plurality of network nodes;
wherein the information related to at least one parameter of models of the plurality of network nodes received from the plurality of network nodes comprises the trained local models.

14. The apparatus of claim 1, wherein the instructions, when executed by the at least one processor, cause the apparatus at least to:
transmit, to the network nodes within the at least one cluster, the at least one global model.

15. The apparatus of claim 1, wherein the instructions, when executed by the at least one processor, cause the apparatus at least to:
provide access to the at least one global model to the network nodes within the at least one cluster.

16. The apparatus of claim 1, wherein the instructions, when executed by the at least one processor, cause the apparatus at least to:
determine a global model per the at least one cluster using the information related to the at least one parameter of models of the plurality of network nodes.

17. The apparatus of claim 1, wherein the plurality of network nodes comprise radio access network nodes.

18. The apparatus of claim 1, wherein the at least one global model is a trained global model for the respective at least one cluster.

19. An apparatus comprising:
at least one processor; and
at least one memory storing instructions that, when executed by the at least one processor, cause the apparatus at least to:
transmit, to a network entity, information related to at least one parameter of a model of the apparatus;
receive, from the network entity, an indication to perform federated learning with the network entity, in response to the apparatus being within a cluster of network nodes similar to the apparatus based on at least one similarity criterion and the information related to the at least one parameter of the model of the apparatus; and
perform federated learning with the network entity, in response to receiving from the network entity the indication to perform federated learning with the network entity.

20. The apparatus of claim 19, wherein the instructions, when executed by the at least one processor, cause the apparatus at least to:
receive, from the network entity, an indication to perform local model training for the federated learning.

21. The apparatus of claim 19, wherein the instructions, when executed by the at least one processor, cause the apparatus at least to:
receive, from the network entity, an indication to perform local model training, in response to the apparatus not belonging to any cluster of network nodes.

22. The apparatus of claim 21, wherein the local model training is performed using transfer learning.

23. The apparatus of claim 21, wherein the apparatus not belonging to any cluster is based on at least one or more of density estimation, or thresholding.

24. The apparatus of claim 19, wherein the instructions, when executed by the at least one processor, cause the apparatus at least to:
receive, from the network entity, an indication to perform transfer learning with a network node, in response to the apparatus not belonging to any cluster of network nodes; and
perform transfer learning using the network node received with the indication to perform transfer learning received from the network entity.

25. The apparatus of claim 24, wherein the network node belongs to a cluster of network nodes having similar local models.

26. The apparatus of claim 24, wherein the instructions, when executed by the at least one processor, cause the apparatus at least to:
receive, from the network entity, an indication of a model of the network node with which to perform the transfer learning.

27. The apparatus of claim 26, wherein a Euclidean distance between a model of the apparatus and the model of the network node with which to perform transfer learning is smaller than Euclidean distances between the model of the apparatus and models of other network nodes.

28. The apparatus of claim 19, wherein the instructions, when executed by the at least one processor, cause the apparatus at least to:
receive, from the network entity, an indication to perform transfer learning with a trained global model of a cluster, in response to the apparatus not belonging to any cluster of network nodes;
wherein, based on a similarity criterion, a similarity metric of the apparatus that does not belong to any cluster of network nodes is more similar to a similarity metric of network nodes that belong to the cluster having the trained global model than to a similarity metric of networks nodes that do not belong to the cluster having the trained global model.

29. The apparatus of claim 19, wherein the information related to the at least one parameter of a model of the apparatus comprises at least one of:
embeddings of the at least one parameter of the model of the apparatus, or
local training data samples used to generate the model of the apparatus.

30. The apparatus of claim 29, wherein the embeddings are based on at least one of:
a downlink physical resource block usage time series, or
an uplink physical resource block usage time series, or
a throughput time series, or
a number of radio resource control connected users, or
a number of radio resource control active users, or
principal component analysis, or
t-distributed stochastic neighbor embedding.

31. The apparatus of claim 19, wherein the instructions, when executed by the at least one processor, cause the apparatus at least to:
receive, from the network entity, a request for the information related to the at least one parameter of the model of the apparatus;
wherein the information related to the at least one parameter of the model of the apparatus is transmitted in response to receiving the request for the information.

32. The apparatus of claim 19, wherein the instructions, when executed by the at least one processor, cause the apparatus at least to:
transmit, to the network entity, a trained local model of the apparatus, the trained local model configured to be used to learn a global model for the cluster of the network nodes;
wherein the information related to the at least one parameter of a model of the apparatus transmitted to the network entity comprises the trained local model of the apparatus.

33. The apparatus of claim 19, wherein the instructions, when executed by the at least one processor, cause the apparatus at least to:
receive, from the network entity, the global model; and
perform inference using the global model.

34. The apparatus of claim 19, wherein the instructions, when executed by the at least one processor, cause the apparatus at least to:
obtain access to the global model; and
perform inference using the global model.

35. The apparatus of claim 19, wherein the apparatus comprises a radio access network node.

36. An apparatus comprising:
at least one processor; and
at least one memory storing instructions that, when executed by the at least one processor, cause the apparatus at least to:
receive or access a global model, wherein the global model is based on federated learning with a cluster of similar network nodes;
receive or access a local model of a network node; and
perform inference using at least one of: the global model based on federated learning or the local model of the network node.

37. The apparatus of claim 36, wherein the local model is based on transfer learning with a network node that is not part of the cluster.

38. The apparatus of claim 36, wherein the apparatus comprises a user equipment.

39. A method comprising:
receiving, from a plurality of network nodes, information related to at least one parameter of models of the plurality of network nodes;
determining at least one cluster of the plurality of network nodes based on at least one similarity criterion and the information related to the least one parameter of models of the plurality of network nodes; and
determining at least one global model for the at least one cluster using local models of network nodes that belong to the at least one cluster.

40. A method comprising:
transmitting, to a network entity, information related to at least one parameter of a model of an apparatus;
receiving, from the network entity, an indication to perform federated learning with the network entity, in response to the apparatus being within a cluster of network nodes similar to the apparatus based on at least one similarity criterion and the information related to the at least one parameter of the model of the apparatus; and
performing federated learning with the network entity, in response to receiving from the network entity the indication to perform federated learning with the network entity.

41. A method comprising:
receiving or accessing a global model, wherein the global model is based on federated learning with a cluster of similar network nodes;
receiving or accessing a local model of a network node; and
performing inference using at least one of: the global model based on federated learning, or the local model of the network node;
with the network entity, in response to the apparatus being within a cluster of network nodes similar to the apparatus based on at least one similarity criterion and the information related to the at least one parameter of the model of the apparatus; and
performing federated learning with the network entity, in response to receiving from the network entity the indication to perform federated learning with the network entity.
